(19) United States
(12) Patent Application Publication
(10) Pub. No.: US 2026/0116527 A1
(43) Pub. Date: Apr. 30, 2026

(54) DEVICE, SYSTEM, AND METHOD

(71) Applicant: Liebherr-Aerospace Lindenberg GmbH, Lindenberg (DE)

(72) Inventors: Stefan HÖCHSTÖTTER, Röthenbach (DE); Uwe SCHUMANN, Tettnang (DE); Matthias MAUCHER, Leutkirch (DE)

(21) Appl. No.: 19/368,681

(22) Filed: Oct. 24, 2025

(30) Foreign Application Priority Data
Oct. 24, 2024 (DE) 10 2024 131 032.4

(51) Int. Cl. B64C 9/32; F16D 55/36; F16D 66/00

(52) U.S. Cl. CPC B64C 9/32; F16D 55/36; F16D 66/00; F16D 2066/003

(57) ABSTRACT

The present disclosure relates to a device for force transmission, comprising a first transmission element, a second transmission element, and an intermediate element, wherein the first transmission element and/or the second transmission element can be arranged in such a way that a force can be transmitted between the first transmission element and the second transmission element, wherein the intermediate element is configured in such a way and is arranged with the first transmission element in such a way that a force can be transmitted between the first transmission element and the intermediate element, wherein the intermediate element is movable by the first transmission element and is configured and/or arranged in such a way that a resistance is exerted against a movement of the intermediate element caused by the first transmission element.

### CROSS REFERENCE TO RELATED APPLICATION

The present application claims priority to German Patent Application No. 10 2024 131 032.4 filed on Oct. 24, 2024. The entire contents of the above-listed application are hereby incorporated by reference for all purposes.

### TECHNICAL FIELD

The present disclosure relates to a device for force transmission, comprising a first transmission element, a second transmission element, and an intermediate element, wherein the first transmission element and/or the second transmission element can be arranged in such a way that a force can be transmitted between the first transmission element and the second transmission element, wherein the intermediate element is configured in such a way and is arranged with the first transmission element in such a way that a force can be transmitted between the first transmission element and the intermediate element.

### BACKGROUND

Flaps, for example landing flaps, of aeroplanes with air foils, should not move without being commanded, in the event of a fault. A technical solution for this that is known from the prior art offers the use of mechanically triggered return brakes or “no-back brakes”.

### SUMMARY

A possible fault for example in the form of a dormant failure of a safety-relevant device of this kind is not allowable and should be identified.

It is known from the prior art that the functionality of these return brakes is checked manually at regular intervals by what is known as an “in situ port”. For example, a mechanic performs this check directly on the actuator with the return brake and checks the functionality of the return brake manually.

This check, in particular for a self-switching return brake, takes place for example by means of a manual “check device”.

It is also known from the prior art to monitor or to check such return brakes by recording or monitoring input and output torque.

It is also known to measure and evaluate a reaction torque, for example of stator elements, of the return brake, as a result of which monitoring of the return brake can take place.

Since the check of the functionality of the return brakes according to the prior art often takes place manually and on site, directly on the actuator, it cannot take place after every flight, for economic and practical reasons. Between the manual checks, the state of the return brake is not known, and therefore dormant failures are not noticed, which is allowable for a limited time period according to current admissibility requirements. Should the admissibility requirements be tightened in this respect, a continuous monitoring of the return brakes of an aircraft may become an essential requirement.

The recording or monitoring of the input and output torque requires complex sensor means, in which measuring signals are recorded and transmitted on rotating parts.

The measuring and evaluation of the reaction torque takes place by means of strain gauges, which requires complex measuring technology.

Against this background, the object of the present disclosure is that of improving an above-mentioned device, in particular with regard to monitoring of the functionality, and to reduce or even entirely eliminate the disadvantages of the prior art.

This object is achieved by the subject matter having the features as described herein.

According thereto, it is provided according to the disclosure that the intermediate element is movable by the first transmission element and is configured and/or arranged in such a way that a resistance is exerted against a movement of the intermediate element caused by the first transmission element.

Within the meaning of this disclosure, a force includes both a force in the sense of a force vector, and/or a torque in the sense of a rotational force.

The first transmission element and the second transmission element can be able to be arranged in such a way that a force can be transmitted between the first transmission element and the second transmission element via a force fit, for example a friction fit and/or force fit.

It is optionally additionally or alternatively provided that the intermediate element is movable by the second transmission element and is configured and/or arranged in such a way that a resistance is exerted against a movement of the intermediate element caused by the second transmission element.

The device and/or the intermediate element optionally comprises means which are configured and arranged in such a way that a resistance is exerted against a movement of the intermediate element.

It is optionally provided that the device and/or the intermediate element comprises one or more spring elements, wherein the resistance against the movement of the intermediate element is exerted by the or one of the spring elements.

It is optionally provided that the device comprises a sensor, for example a proximity sensor, which is configured and arranged so as to record a movement and/or a position of the intermediate element.

It is optionally provided that the intermediate element is rotatable.

It is optionally provided that the first transmission element is arranged and/or mounted in the intermediate element.

It is optionally provided that the device comprises a housing and the intermediate element is arranged and/or mounted in the housing.

It is optionally provided that the device comprises a shaft and the second transmission element is arranged and/or mounted on the shaft.

It is optionally provided that the first transmission element comprises one or more stator elements and the second transmission element comprises one or more rotor elements.

A rotatable mounting of the stator elements optionally takes place, for example in and/or by the intermediate element. The stator elements and the intermediate element may form a stator cage. The amount of the rotation of said stator cage against one or more spring elements can be a measurement for the reaction torque of the stator elements.

The stator elements and the rotor elements are optionally discoid and/or lamellar.

It is optionally provided that the device is a clutch for an aircraft or a brake for an aircraft, for example a return brake.

The device can be a return brake or a backstop.

The return brake is optionally monitored continuously.

The return brake is optionally configured and/or arranged in such a way as to prevent one or more flaps, for example actuation flaps, of the system from moving automatically. This functionality is optionally monitored continuously.

The device is optionally a self-switching return brake and can be continuously monitored with regard to its functionality.

In this way, continuous and automatic checking of the functionality of the return brake, which can for example take place with each flight, with easily implementable sensor means, is made possible.

The disclosure also relates to a system comprising a device according to the disclosure and a component and a structure, wherein the first transmission element and/or the intermediate element is connected to the structure, and the second transmission element is connected to the component.

It is optionally provided that the system is a high-lift system or an actuation system of an aircraft, the structure is a wing or a fuselage, and the component is a flap.

The device can be part of a trimmable horizontal stabilizer actuator (THSA) or a high-lift system.

The device is optionally part of a safety component or is a safety component, for example, a brake, clutch, or torque controller, which undergoes regular checks.

The disclosure also relates to a method for continuous, monitoring of a device according to the disclosure or of a system according to the disclosure, said method having the steps of:
arranging the first transmission element and the second transmission element in such a way that a force can be transmitted between the first transmission element and the second transmission element;
impressing a force on the first transmission element and/or second transmission element; and
evaluating whether sufficient movement of the intermediate element takes place.

Optionally a rotational movement of the intermediate element, caused by the reaction torque of the first transmission element, for example from stator elements of the device, is used for the monitoring. Optionally, the technical outlay for monitoring the device is significantly reduced compared with the prior art.

Optionally, continuous monitoring of the safety-critical functionality of the device takes place.

The monitoring is optionally evaluated automatically.

Advantageously, simple sensor means provide cost-effective monitoring.

Advantageously, the use of simple sensor means is made possible.

Advantageously, no signals are transmitted from rotating or rotatable parts, in particular to a housing.

At this point it is noted that the terms “a” and “an” do not necessarily refer to exactly one of the elements, even if this is a possible embodiment, but rather can also denote a plurality of the elements. Likewise, the use of the plural also includes the presence of the element in question in the singular, and vice versa the singular also includes a plurality of the element in question. Furthermore, all the features of the disclosure described herein can be combined with one another as desired or claimed in isolation from one another.

### BRIEF DESCRIPTION OF THE FIGURES

Further advantages, features and effects of the present disclosure emerge from the following description of embodiments, with reference to the figures, in which identical or similar parts are denoted by the same reference signs. In the figures:

FIG. 1: is a cross-section through an embodiment of a device according to the disclosure.

FIG. 2: is a longitudinal section through an embodiment of a device according to the disclosure.

FIG. 3: is a perspective view of an embodiment of a device according to the disclosure.

### DETAILED DESCRIPTION

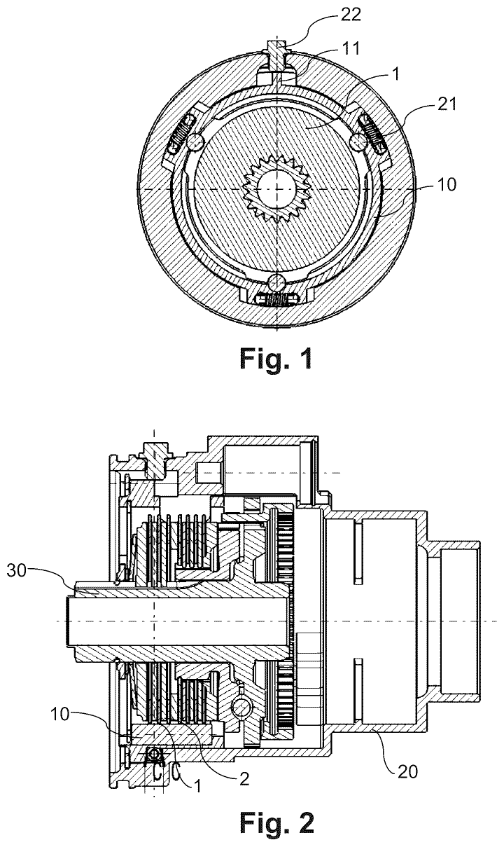

FIGS. 1 to 3 show a device configured as a return brake for an aircraft.

In the case of self-switching return brakes, a brake mechanism is activated by a “pushing load” and ultimately a braking torque is generated within a package that comprises or consists of stator elements 1 and rotor elements 2. The package can be referred to as a brake package or as a lamella package.

Return brakes of landing flap actuators are activated e.g. when the landing flaps are retracted after startup of the aircraft.

The device may comprise a first transmission element, a second transmission elements, and an intermediate element. The first transmission element may comprise the stator element 1. The second transmission element may comprise the rotor element 2.

The stator elements 1 are mounted in an intermediate element 10, as follows from FIG. 1.

The intermediate element 10 is supported against the housing 20 of the device via spring elements 21, and can be rotated against the spring force of the spring elements 21. The device comprises three spring elements 21, wherein these are arranged regularly along the periphery of the intermediate element 10.

The transmission of a braking torque from the rotor elements 2 to the stator elements 1 causes a rotational movement of the stator elements 1 or of the intermediate element 10. The stator elements 1 are thus rotatably mounted via the intermediate element 10, wherein a limited rotation of the intermediate element 10 against the spring elements 21 is permitted.

This rotational movement of the intermediate element 10 can be detected by, for example, proximity sensors or proximity switches.

In embodiments from the prior art, the stator elements 1 are usually mounted in the housing 20 of the device, whereby a reaction torque is transmitted to the housing 20.

In the embodiment of the device according to the disclosure, the reaction torque is transmitted to the housing 20 via the intermediate element 10 and the spring elements 21.

FIG. 2 shows that the stator elements 1 and the rotor element 2 form a package, wherein the stator elements 1 are mounted in the housing 20 via the intermediate element 10 and the rotor elements 2 are mounted on a shaft 30 of the device.

Pressing together the stator elements 1 and the rotor elements 2 makes it possible for force to be transmitted between the stator elements 1 and rotor elements 2 by frictional connection, whereby for example a braking torque prevailing at the shaft 30 can be generated, wherein the reaction torque caused by the braking torque is supported on the housing 20.

The rotational movement of the stator elements 1 arising during braking can be detected or recorded by the integrated intermediate element 10, which, together with the stator elements 1, forms a rotatably mounted stator cage.

The intermediate element 10 is arranged between the stator elements 1 and the housing 20 and is rotatably mounted in the housing 20, wherein the rotation is limited by the spring elements 21 and/or by stops.

Spring elements 21 are provided between the intermediate element 10 and the housing. The intermediate element 10 comprises a target 11 for the proximity sensor 22, as can be seen from FIG. 1.

The functionality of the return brake can thus be ensured and monitored by the definition of the spring preload and/or the characteristic of the spring elements 21 based on a minimum required braking torque and in connection with the detected movement after overcoming the spring preload and/or the necessary spring force of the spring element 21. If the braking torque is too low, on account of the resistance by the spring force of the spring elements 21 too small a rotation of the stator elements 1 or of the intermediate element 10 occurs and no signal is generated by the proximity sensor 22.

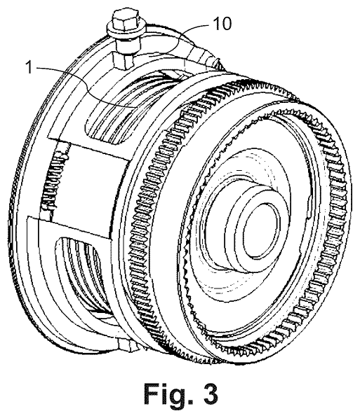

It is clear from FIG. 3 how the intermediate element 10, as a part of a stator cage, surrounds the stator elements 1.

The return brake is part of a high-lift system, wherein the high-lift system comprises a plurality of return brakes. A return brake of the high-lift system can be a permanent brake, and a return brake of the high-lift system can be a main brake. The return brakes of the high-lift system form a braking mechanism.

Depending on what reaction torque is intended to be monitored, either the stator elements of the permanent brake, which is in particular required for activating the braking mechanism, and/or the stator elements of the main brake or all the stators of the braking mechanism can be mounted in exactly one rotatable intermediate element. The device can thus be a braking mechanism comprising a plurality of brakes. In other words, stator elements of different brakes, in particular return brakes, can be arranged or mounted in the intermediate element.

1. A device for force transmission, comprising a first transmission element, a second transmission element, and an intermediate element, wherein the first transmission element and/or the second transmission element can be arranged in such a way that a force can be transmitted between the first transmission element and the second transmission element, wherein the intermediate element is configured in such a way and is arranged with the first transmission element in such a way that a force can be transmitted between the first transmission element and the intermediate element, wherein the intermediate element is movable by the first transmission element and is configured and/or arranged in such a way that a resistance is exerted against a movement of the intermediate element caused by the first transmission element.

2. The device according to claim 1, wherein the device and/or the intermediate element comprises one or more spring elements, wherein the resistance against the movement of the intermediate element is exerted by the or one of the spring elements.

3. The device according to claim 1, wherein the device comprises a sensor which is configured and arranged so as to record a movement and/or a position of the intermediate element.

4. The device according to claim 1, wherein the intermediate element is rotatable.

5. The device according to claim 1, wherein the first transmission element is arranged and/or mounted in the intermediate element.

6. The device according to claim 1, wherein the device comprises a housing and the intermediate element is arranged and/or mounted in the housing.

7. The device according to claim 1, wherein the device comprises a shaft and the second transmission element is arranged and/or mounted on the shaft.

8. The device according to claim 1, wherein the first transmission element comprises one or more stator elements and the second transmission element comprises one or more rotor elements.

9. The device according to claim 1, wherein the device is a clutch for an aircraft or a brake for an aircraft.

10. A system comprising the device according to claim 1 αnd a component and a structure, wherein the first transmission element and/or the intermediate element is connected to the structure, and the second transmission element is connected to the component.

11. The system according to claim 10, wherein the system is a high-lift system or an actuation system of an aircraft, the structure is a wing or a fuselage, and the component is a flap.

12. A method for continuous monitoring of the device according to claim 1, comprising the steps of:
arranging the first transmission element and the second transmission element in such a way that a force can be transmitted between the first transmission element and the second transmission element;
impressing a force on the first transmission element and/or second transmission element; and
evaluating whether sufficient movement of the intermediate element takes place.

13. The device according to claim 3, wherein the sensor is a proximity sensor.

14. The device according to claim 9, wherein the device is a return brake.
